(19) United States
(12) Patent Application Publication
(10) Pub. No.: US 2015/0120943 A1
(43) Pub. Date: Apr. 30, 2015

(54) Secure mobile access to resources within a private network

(71) Applicant: HomerSoft sp. Zo.o, Krakow (PL)

(72) Inventors: Szymon Slupik, Krakow (PL); Marcin Bis, Warszawa (PL); Lukasz Nowak, Krakow (PL)

(73) Assignee: HomerSoft sp. zo.o., Krakow (PL)

(21) Appl. No.: 14/066,064

(22) Filed: Oct. 29, 2013

(51) Int. Cl. H04L 29/08

(52) U.S. Cl. CPC H04L 67/141
USPC 709/227

(57) ABSTRACT

A technique is disclosed that provides a secure end-to-end connection between a mobile station in a public network and a resource server in a private network. First, a virtual private network (VPN) connection is established by the resource server within the private network, to a VPN/socket secure (SOCKS) proxy in the public network. Subsequently, the SOCKS proxy receives an access request from the mobile station and, in response, sets up a Hypertext Transport Protocol Secure (HTTPS) connection between the resource server and mobile station. Then, a reverse proxy service operating at the resource server retrieves data packets from a resource device, such as a webcam, and encrypts and pushes the packets to the mobile station.

### FIELD OF THE INVENTION

moon The present invention relates to telecommunications in general, and, more particularly, to providing secure mobile access to resources within a private network.

### BACKGROUND OF THE INVENTION

FIG. 1 depicts telecommunications system 100 in the prior art. System 100 comprises private network 101, mobile network 111, and public Internet network 121, interconnected as shown.

Private network 101 as depicted is situated within a home and, as such, is a residential data network. Private network 101 comprises a collection of links and nodes, including webcam system 102 and router 104, interconnected as shown and as part of a local area network (LAN) that enables telecommunication between devices. One or more of the links and nodes in private network 101, including webcam system 102, are behind a network address translation (NAT) firewall implemented in router 104.

Webcam system 102 comprises a computer appliance that is capable of generating one or more video packets from its camera. System 102 further comprises resource server functionality and, as such, is capable of linking other computers or electronic devices together, in this case providing the video packets to a second device when requested to do so. In particular, system 102 is capable of coordinating the sending of the video data packets to an accessing device outside of private network 101.

Mobile network 111 comprises mobile station 112 and wireless provider infrastructure 113, interconnected as shown, and enables telecommunications between a wireless user at mobile station 112 and a second party.

Mobile station 112 is a wireless telecommunications terminal that is capable of transmitting and/or receiving communications wirelessly. Mobile station 112 comprises the hardware and software necessary to be compliant with the protocol standards used in mobile network 111. Mobile station 112 is capable of:
i. receiving an incoming (i.e., “mobile-terminated”) telephone call or other communication (e.g., SMS text, email, media stream, etc.),
ii. transmitting an outgoing (i.e., “mobile-originated”) telephone call or other communication (e.g., SMS text, email, media stream, etc.), and
iii. receiving, transmitting, or otherwise processing one or more signals in support of capabilities i and ii.

Mobile station 112 is known as a “smartphone” because it is built on a mobile operating system that provides the device with more advanced computing capability and connectivity than a basic feature phone. Furthermore, mobile station 112, as a smartphone, also has a touchscreen that is used as an input/output (I/O) device by its user and access to the public Internet (i.e., network 121).

Wireless provider infrastructure 113 comprises a collection of radio equipment, base station equipment, switching equipment, service-control equipment, and other equipment that enable wireless telecommunications for one or more mobile stations with one or more other terminals. Infrastructure 113 provides wireless telecommunications service in well-known fashion to mobile station 112.

Public Internet network 121 comprises a collection of links and nodes that enable telecommunication between devices. Network 121 provides the other networks of system 100 with connectivity to each other, via bridging infrastructure 122.

Bridging infrastructure 122 is a collection of software and hardware that responds to requests across telecommunications system 100 to provide connectivity between, for example, mobile station 112 and webcam system 102.

Because mobile station 112 is a smartphone, its user can sometimes take advantage of its WiFi capability and use the smartphone to easily access one or more devices, such as webcam system 102, via the WiFi coverage area that is present within network 101. This is because the smartphone, while operating in WiFi mode, is always able to discover the Internet Protocol (IP) addresses of the devices that are present in the same WiFi home network. This assumes, however, that the mobile station is within the home WiFi coverage area.

But outside of private network 101 (i.e., outside of the home), the smartphone has to connect through a wireless service provider's mobile network—in this scenario, mobile network 111—or through any other network outside of the home private LAN network, for that matter. Consequently, connectivity between the smartphone on the outside and an in-home device is a problem for at least three reasons. First, the home network is behind a NAT service as mentioned above, making the private (internal) IP addresses not visible to the outside world. Second, the home or provider network's firewall service allows only outgoing connections, and not connections that are incoming to the home. And third, the public (external) IP address of the home network is not static and changes over time for a variety of reasons, such as the address expiring after a predetermined amount of time, the Internet service provider of the home user deliberately refreshing the address, and so on.

As a result, the mobile station operating in a network external to the home network does not know how to connect directly to an in-home device.

Many prior-art approaches for providing data packets from a home webcam to a smartphone outside the home use what is referred to as a “cloud service,” in which a machine essentially is provided somewhere on the Internet at a known, public IP address. Using the cloud service, two connections are made, one being a home-to-cloud connection and the other being a smartphone-to-cloud connection. These connections are then bridged together by bridging or routing via infrastructure 122. Each connection can be secured individually.

This is disadvantageous, however, in that the bridge —that is, the point at which the two connections are joined—is itself unsecured. This is problematic to at least some mobile users who want to know that the video data from their webcams, for example, are secure from end-to-end, when accessing their home webcams or other home resource devices. And even if a mobile user does, in fact, trust the service company itself that provides the home access through its bridge, an unscrupulous employee of the access provider might allow unauthorized access to the data packets as they cross the unsecured bridge.

What is needed is a technique to provide secure mobile access to resources within a private network, from outside said network, without some of the disadvantages in the prior art.

### SUMMARY OF THE INVENTION

The present invention enables a mobile station, and its associated user, to access a private network such as a home network or office network, from outside the network and in a secure manner.

The techniques disclosed herein are based on a few insights experienced by the inventors. First, in setting up a secure end-to-end connection between two nodes across two visible networks, such as public networks, the initiator can use a socket secure proxy, such as a SOCKS proxy as is known in the art, in order for the near node to retrieve data packets from the far node. In doing so, two addresses have to be specified to the other network: i) the server proxy address, in order to reach the proxy, and ii) the destination address of where the other network should send the data packets, so that the proxy knows where to forward the packets.

Unfortunately, the foregoing SOCKS proxy technique fails when, for example, one of the nodes is within a private network and the other node is not. This is because the proxy service still does not know where to forward the retrieval request because the node in the private network is not visible from the proxy, which is outside of the private network and, as a result, in a different address space.

The inventors perceived that the above shortcoming of a SOCKS proxy service can be solved by first establishing a virtual private network (VPN) connection between a resource server in the private network and a proxy situated somewhere in the public Internet—for example, at a cloud-based service. Because the VPN connection is established as an outgoing connection (i.e., from within the private network to the proxy in the cloud), the connectivity problems between the mobile station and private network in the prior art are avoided. Once the resource server has initiated a VPN connection, the SOCKS proxy service is then used to complete the connection to the mobile station.

The inventors further perceived that proxy services are conventionally used the other way around—that is, to manage a connection from within a private network to outside the private network. In accordance with the illustrative embodiment of the present invention, a proxy service is instead being used to allow outside access to within the private network.

In addition, proxy service conventionally has been a generally available service for anybody. But in accordance with the illustrative embodiment, only users who have accounts with the illustrative proxy service are allowed access. Such access is governed by firewall rules such that a given user only has access to the one VPN “pipe” that leads to his private network only, thereby allowing only a given user to go to his particular private network at home or at the office.

In order to provide a secure end-to-end connection, the technique disclosed herein involves the following actions. First, the VPN connection is established by the resource server within the private network, to a VPN/SOCKS proxy in the public network. Subsequently, the SOCKS proxy in the cloud receives an access request from a mobile station and, in response, sets up a Transmission Control Protocol/Internet Protocol (TCP/IP) connection between the resource server and mobile station. Such a connection can be a Hypertext Transport Protocol Secure (HTTPS) connection or a plain TCP connection, for example and without limitation. Then, a reverse proxy service operating at the resource server retrieves data packets from a resource device, such as a webcam, and encrypts and pushes the packets to the mobile station.

A first embodiment of the present invention comprises: establishing a first connection between a resource server computer and a second server computer, wherein the resource server computer is assigned a private Internet Protocol (IP) address that is within the address space of a private network, wherein the second server computer has a public IP address that is within the address space of a public network, and wherein the second server computer provides a socket secure (SOCKS) proxy service; receiving, by the second server computer, a request to initiate a second connection, wherein the second connection is between an accessing device and the resource server computer, and wherein the initiation request comprises the private IP address assigned to the resource server computer; routing, by the proxy service of the second server computer, the initiation request to the resource server computer via the first connection, wherein the routing is based on the private IP address assigned to the resource server computer; and establishing the second connection, based on the resource server computer receiving the initiation request.

A second embodiment of the present invention comprises: a resource server computer for providing one or more data packets to an accessing device; and a second server computer for: i) establishing a first connection with the resource server computer, wherein the resource server computer is assigned a private Internet Protocol (IP) address that is within the address space of a private network, wherein the second server computer has a public IP address that is within the address space of a public network, and wherein the second server computer is capable of providing a socket secure (SOCKS) proxy service, ii) receiving a request to initiate a second connection, wherein the second connection is between the accessing device and the resource server computer, and wherein the initiation request comprises the private IP address assigned to the resource server computer, and iii) routing, by the proxy service of the second server computer, the initiation request to the resource server computer via the first connection, wherein the routing is based on the private IP address assigned to the resource server computer; wherein the resource server is configured to provide the one or more data packets to the accessing device after the second connection has been established based on the resource server computer receiving the initiation request.

### BRIEF DESCRIPTION OF THE DRAWINGS

FIG. 1 depicts telecommunications system 100 in the prior art.

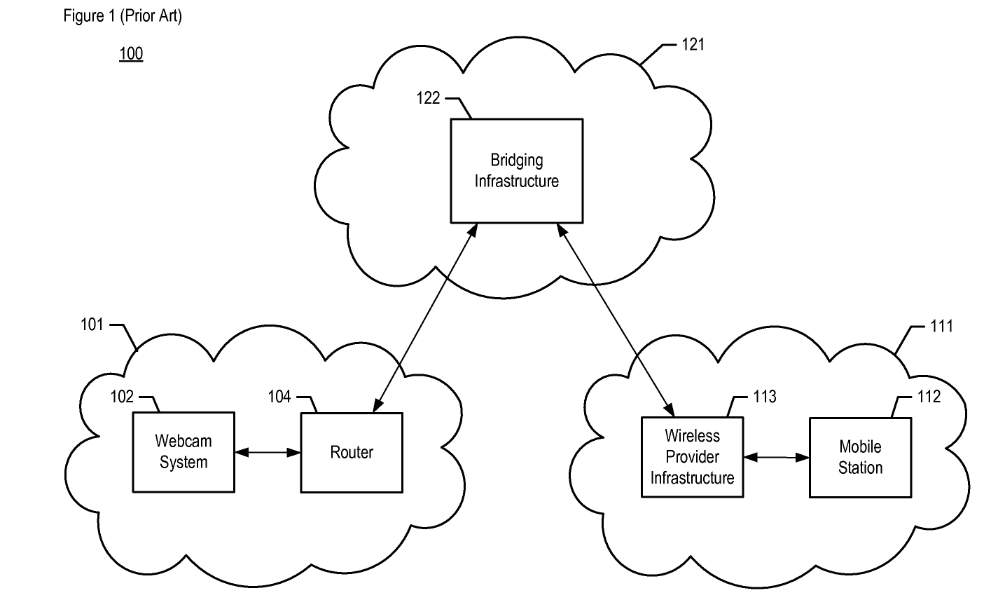

FIG. 2 depicts telecommunications system 200, in accordance with the illustrative embodiment of the present invention.

FIG. 3 depicts salient components of resource server 203 according to the illustrative embodiment.

FIG. 4 depicts salient components of VPN/proxy server 222 according to the illustrative embodiment.

FIG. 5 depicts a message flow diagram of the salient processes performed and messages exchanged in accordance with providing mobile station 212 with secure access to resources within private network 201.

### DETAILED DESCRIPTION

To facilitate explanation and understanding of the present invention, the following description sets forth several details. However, it will be clear to those having ordinary skill in the art, after reading the present disclosure, that the present invention may be practiced without these specific details, or with an equivalent solution or configuration. Furthermore, some structures, devices, and operations that are well known in the art are depicted in block diagram form in the accompanying figures in order to keep salient aspects of the present invention from being unnecessarily obscured.

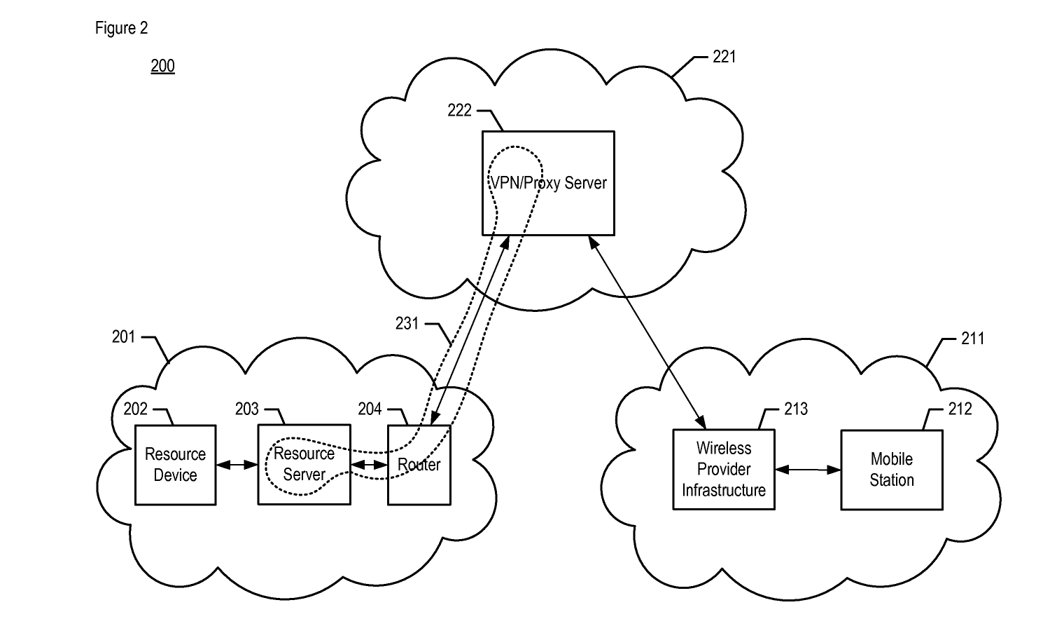

FIG. 2 depicts telecommunications system 200, in accordance with the illustrative embodiment of the present invention. System 200 comprises: private network 201, mobile network 211, public Internet network 221, and virtual private network (VPN) 231. Private network 201 comprises resource device 202, resource server computing system 203, and router 204. Mobile network 211 comprises mobile station 212 and wireless provider infrastructure 213. Public Internet 221 comprises VPN/proxy server computing system 222. The aforementioned elements are interconnected as shown.

Resource device 202 is a computer appliance that is capable of generating one or more data packets, such as data packets conveying a media stream (via “media packets”), and providing them to a second device. In some alternative embodiments, each data packet is referred to as a datagram, segment, block, cell, or frame.

In accordance with the illustrative embodiment of the present invention, device 202 is a webcam that is capable of generating and providing data packets that are representative of a video media stream. It will be clear to those skilled in the art, however, after reading this specification, how to make and use embodiments of the present invention in which device 202 is a different type of device, such as a baby monitor or set-top box, for example and without limitation. Moreover, device 202 in some alternative embodiments can generate packets other and, or in addition to, video packets, such as audio packets, voice packets, and image packets, for example and without limitation.

As depicted in FIG. 2, a single resource device is shown within private network 201. However, it will be clear to those skilled in the art, after reading this specification, how to make and use embodiments in which multiple devices are present within network 201 and are capable of exchanging data packets with resource server 203.

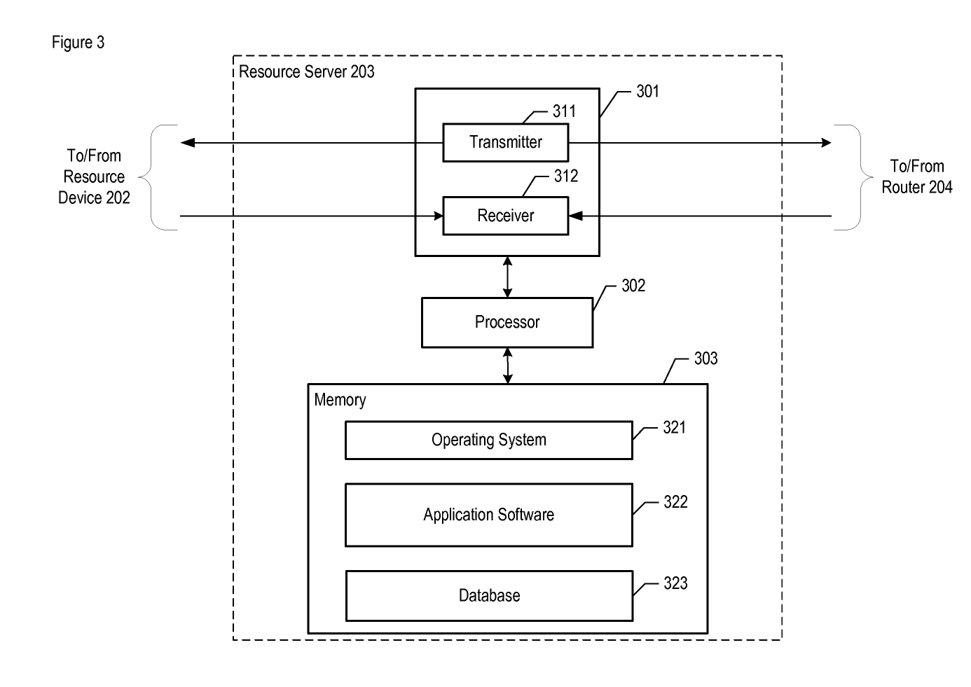

Resource server computing system 203 is a computer appliance, which, as a server computer, is capable of linking other computers or electronic devices together. In particular, system 203 is capable of coordinating the providing of data packets from one or more resource devices within private network 201, such as device 202, to one or more accessing devices outside of private network 201. For the purpose of this specification, system 203 is also referred to as “resource server 203.” System 203 comprises one or more computers having non-transitory memory, processing components, and communication components, and is described in further detail in FIG. 3.

Resource server 203 and resource device 202 communicate with each other via a local area network (LAN) within private network 201. As those who are skilled in the art will appreciate, however, after reading this specification, device 202 can be connected directly to server 203, such as through Universal Serial Bus (USB), FireWire™, or Thunderbolt™, for example and without limitation.

In accordance with the illustrative embodiment of the present invention, resource server 203 provides a reverse proxy service, in that the server i) behaves as a client to one or more resource devices, so that the server is able to request a resource device to provide data packets, and then ii) behaves as a forwarding server in pushing the data packets downstream to an accessing device. In some embodiments, resource server 203 also encrypts the data packets: it can request unencrypted packets from resource device 202, acting as a client, and then encrypt them before forwarding/pushing encrypted packets to an accessing device. In doing so, this technique secures the connections to resource devices that by themselves do not provide encryption capabilities.

In addition to device 202 and server 203, private network 201 comprises a collection of links and nodes, such as router 204, as part of a local area network (LAN) that enables telecommunication between devices in well-known fashion. One or more of the links and nodes in private network 201, including device 202 and server 203, are behind a network address translation (NAT) firewall implemented in router 204. In a residential network, for example, NAT functions are usually implemented in a residential gateway device such as router 204. In this case, the nodes connected to the router would have private IP addresses and the router would have a public IP address to communicate on the Internet. This type of router allows several computers to share one public IP address. A public IP address is synonymous with a globally routable unicast IP address.

In accordance with the illustrative embodiment of the present invention, private network 201 is situated within a home and, as such, is a residential data network. However, in some alternative embodiments, private network 201 can be a commercial data network or yet another type of data network, as those who are skilled in the art will appreciate.

Although telecommunications system 200 as depicted in FIG. 2 comprises only one private network 201, it will be clear to those skilled in the art, after reading this disclosure, how to make and use alternative embodiments of the present invention that comprise any number of private networks, each having one or more resource devices and/or one or more resource servers.

Now referring to mobile network 211, mobile station 212 is a wireless telecommunications terminal that is capable of transmitting and/or receiving communications wirelessly. Mobile station 212 comprises the hardware and software necessary to be compliant with the protocol standards used in mobile network 211 and to perform the processes described below and in the accompanying figures. For example and without limitation, mobile station 212 is capable of:
i. receiving an incoming (i.e., “mobile-terminated”) telephone call or other communication (e.g., SMS text, email, media stream, etc.),
ii. transmitting an outgoing (i.e., “mobile-originated”) telephone call or other communication (e.g., SMS text, email, media stream, etc.), and
iii. receiving, transmitting, or otherwise processing one or more signals in support of capabilities i and ii.
   Furthermore, mobile station 212 is illustratively a smartphone with at least packet data capability provided and supported by network 211. In some alternative embodiments of the present invention, mobile station 212 can be referred to by a variety of alternative names such as a wireless transmit/receive unit (WTRU), a user equipment (UE), a wireless terminal, cell phone, or a fixed or mobile subscriber unit, or can be any other type of device that is capable of operating in a mobile network environment.

A single mobile station 212 is depicted as being present within mobile network 211. However, it will be clear to those skilled in the art, after reading this specification, how to make and use embodiments in which multiple mobile stations are supported.

Wireless provider infrastructure 213 comprises a collection of radio equipment, base station equipment, switching equipment, service-control equipment, and other equipment that enable wireless telecommunications for one or more mobile stations with one or more other terminals. Infrastructure 213 provides wireless telecommunications service in well-known fashion to mobile station 212.

In accordance with the illustrative embodiment, wireless telecommunications service is provided to mobile station 212 according to the Global System for Mobile Communications (GSM) set of standards. After reading this disclosure, however, it will be clear to those skilled in the art how to make and use alternative embodiments of the present invention that operate in accordance with one or more other air-interface standards (e.g., Universal Mobile Telecommunications System “UMTS”, Long Term Evolution “LTE”, CDMA-2000, IS-136 TDMA, IS-95 CDMA, 3G Wideband CDMA, IEEE 802.11 WiFi, 802.16 WiMax, Bluetooth, etc.) in one or more frequency bands.

In some alternative embodiments of the present invention, mobile station 212 might be a different type of end-user device that is capable of accessing resources within private network 201, and might be attempting to access those resources from within a different network than mobile network 211, but still from outside of private network 201. For example and without limitation, device 212 might be instead a desktop computer, laptop computer, hand-held computer, tablet computer, feature phone, pager, personal digital assistant (PDA), dedicated media player, consumer electronic device, wearable computer, smartwatch, smartglasses (e.g., a Google Glass™ platform), specialized remote-control unit, other type of personal computer system, other computing device, or any combination thereof, operating outside of private network 201.

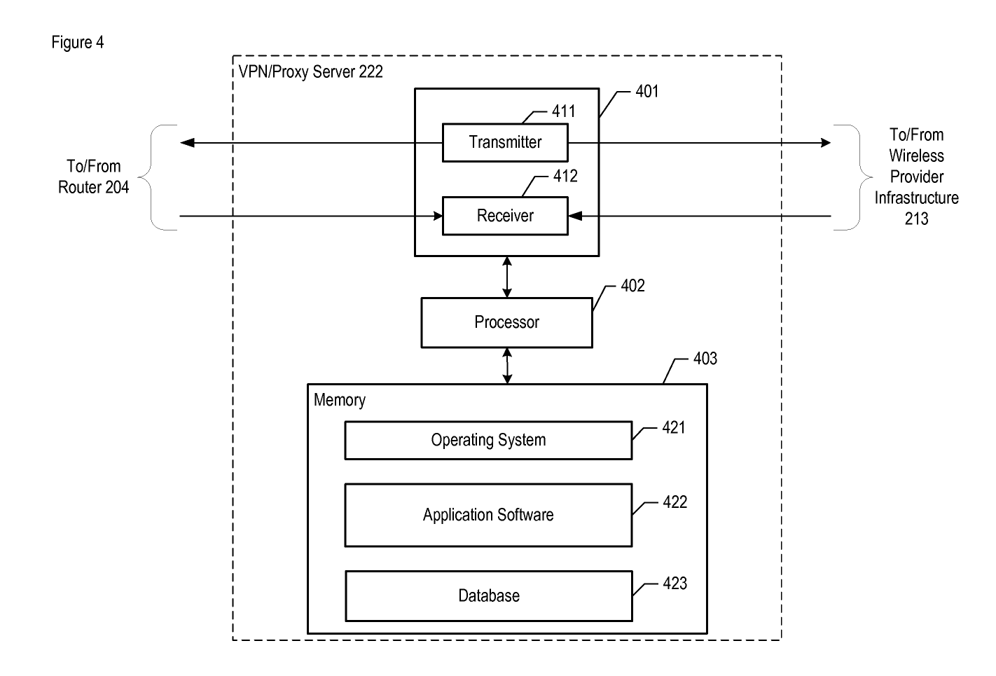

Now referring to network 221, server-computing system 222 is a collection of software and hardware that responds to requests across telecommunications system 200 to provide network services. For the purpose of this specification, system 222 is also referred to as “VPN/proxy server 222.” System 222 comprises one or more computers having non-transitory memory, processing components, and communication components, and is described in further detail in FIG. 4.

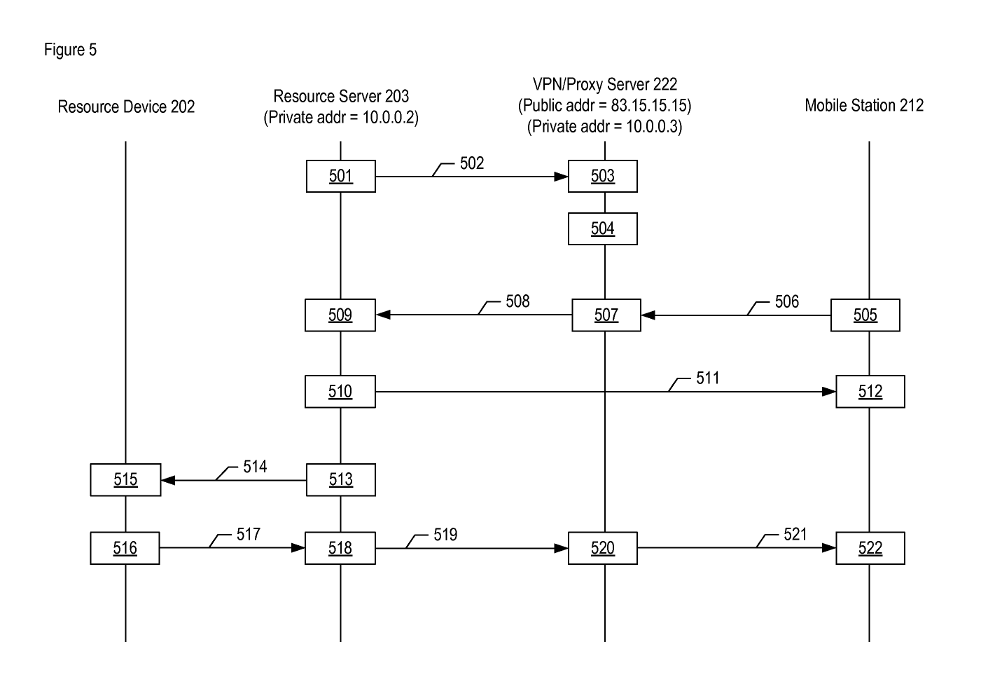

Server 222 provides two services in particular: virtual private network (VPN) server functionality and secure socket (SOCKS) server proxy service, which are described in further detail in FIG. 5. Additionally, server-computing system 222 interacts with resource server 203 via private VPN network 231, in order to provide data packets from one or more resource devices such as resource device 202, to one or more mobile stations such as mobile station 212.

In addition to server 222, public Internet network 221 comprises a collection of links and nodes that enable telecommunication between devices, in well-known fashion. Network 221 provides the other networks of system 200 with connectivity to one other. In accordance with the illustrative embodiment of the present invention, network 221 is the public Internet (sometimes referred to merely as “the Internet”); in some other embodiments of the present invention, network 221 is the Public Switched Telephone Network (PSTN); in still some other embodiments of the present invention, network 221 is a private data network in a different address space than private network 201. As those with ordinary skill in the art will appreciate after reading this disclosure, in some embodiments of the present invention network 221 can comprise one or more of the above-mentioned networks and/or other telecommunications networks, without limitation. Furthermore, it will be clear to those will ordinary skill in the art, after reading this disclosure, that network 221 can comprise elements that are capable of wired and/or wireless communication, without limitation. Additionally, at least a portion of network 221 (e.g., a portion comprising proxy server 222, etc.) might be referred to as “the cloud,” as is known in the art.

FIG. 3 depicts salient components of resource server 203 according to the illustrative embodiment. Resource server 203 comprises: transceiver 301, processor 302, and memory 303, interconnected as shown. Resource server 203 is an apparatus that comprises the hardware and software necessary to perform at least some of the methods and operations described below and in the accompanying figures.

Transceiver 301 comprises transmitter 311, which is a component that enables resource server 203 to telecommunicate with other components and systems by transmitting signals thereto. For example, transmitter 311 enables telecommunication pathways to one or more resource devices 202, server 222, and mobile station 212, for example and without limitation. Transmitter 311 is well known in the art.

Transceiver 301 further comprises receiver 312, which is a component that enables resource server 203 to telecommunicate with other components and systems by receiving signals therefrom. For example, receiver 312 enables telecommunication pathways from one or more resource devices 202, server 222, and mobile station 212, for example and without limitation. Receiver 312 is well known in the art.

Processor 302 is a processing device such as a microprocessor that is well known in the art. Processor 302 is configured such that, when operating in conjunction with the other components of resource server 203, processor 302 executes software, processes data, and telecommunicates according to the operations described herein.

Memory 303 is non-transitory and non-volatile computer storage memory technology that is well known in the art (e.g., flash memory, etc.). Memory 303 stores operating system 321, application software 322, and database 323. Operating system 321 is a collection of software that manages, in well-known fashion, resource server 203's hardware resources and provides common services for computer programs, such as those that constitute application software 322. In accordance with the illustrative embodiment, operating system 321 comprises Linux, while in some alternative embodiments a different operating system is used.

Application software 322 embodies at least some of the processes depicted in FIG. 5, including in particular those corresponding to “Resource Server 203” as labeled.

Database 323 illustratively comprises mappings of which mobile station is requesting data packets from which resource device, among other information.

It will be clear to those having ordinary skill in the art how to make and use alternative embodiments that comprise more than one memory 303; or comprise subdivided segments of memory 303; or comprise a plurality of memory technologies that collectively store operating system 321, application software 322, and database 323.

It will be clear to those skilled in the art, after reading the present disclosure, that in some alternative embodiments the hardware platform of resource server 203 can be embodied as a multi-processor platform, as a sub-component of a larger computing platform, as a virtual computing element, or in some other computing environment—all within the scope of the present invention. In any event, it will be clear to those skilled in the art, after reading the present disclosure, how to make and use resource server 203.

FIG. 4 depicts salient components of VPN/proxy server 222 according to the illustrative embodiment. VPN/proxy server 222 comprises: transceiver 401, processor 402, and memory 403, interconnected as shown. VPN/proxy server 222 is an apparatus that comprises the hardware and software necessary to perform at least some of the methods and operations described below and in the accompanying figures.

Transceiver 401 comprises transmitter 411, which is a component that enables VPN/proxy server 222 to telecommunicate with other components and systems by transmitting signals thereto. For example, transmitter 411 enables telecommunication pathways to resource server 203 and mobile station 212, for example and without limitation. Transmitter 411 is well known in the art.

Transceiver 401 further comprises receiver 412, which is a component that enables VPN/proxy server 222 to telecommunicate with other components and systems by receiving signals therefrom. For example, receiver 412 enables telecommunication pathways from resource server 203 and mobile station 212, for example and without limitation. Receiver 412 is well known in the art.

Processor 402 is a processing device such as a microprocessor that is well known in the art. Processor 402 is configured such that, when operating in conjunction with the other components of VPN/proxy server 222, processor 402 executes software, processes data, and telecommunicates according to the operations described herein.

Memory 403 is non-transitory and non-volatile computer storage memory technology that is well known in the art (e.g., flash memory, etc.). Memory 403 stores operating system 421, application software 422, and database 423. Operating system 421 is a collection of software that manages, in well-known fashion, VPN/proxy server 222's hardware resources and provides common services for computer programs, such as those that constitute application software 422.

Application software 422 embodies at least some of the processes depicted in FIG. 5, including in particular those corresponding to “VPN/Proxy Server 222” as labeled.

Database 423 illustratively comprises mappings of which mobile station is requesting data packets from which resource device, among other information.

It will be clear to those having ordinary skill in the art how to make and use alternative embodiments that comprise more than one memory 403; or comprise subdivided segments of memory 403; or comprise a plurality of memory technologies that collectively store operating system 421, application software 422, and database 423.

It will be clear to those skilled in the art, after reading the present disclosure, that in some alternative embodiments the hardware platform of VPN/proxy server 222 can be embodied as a multi-processor platform, as a sub-component of a larger computing platform, as a virtual computing element, or in some other computing environment—all within the scope of the present invention. In any event, it will be clear to those skilled in the art, after reading the present disclosure, how to make and use VPN/proxy server 222.

FIG. 5 depicts a message flow diagram of the salient processes performed and messages exchanged in accordance with providing mobile station 212 with secure access to resources within private network 201.

For illustrative purposes, the following IP addresses apply to the various elements involved. There is a VPN connection set up between the resource server and the VPN/proxy server. The connection originates at resource server 203 with a private (i.e., internal) IP address of 10.0.0.2 and is terminated at the VPN/proxy server with a private address of 10.0.0.3, which is the address of a VPN tunnel that traverses the VPN connection between the VPN server and resource server. VPN/proxy server 222 also has an external (public) IP address of 83.15.15.15. The private VPN IP address of server 203 is within the address space of virtual private network 231. The public IP addresses of server 203 and VPN/proxy server 222 are within the address space of public network 221.

In accordance with the illustrative embodiment of the present invention, the depicted equipment use standardized protocols for communicating messages, in order to ensure that each message is properly routed throughout networks 201, 211, 221, and 231. The higher-layer (e.g., application layer) content of at least some of the messages may be specifically tailored where needed, in order to enable the invention as claimed.

Establishing a VPN Connection—

Beginning with process 501, resource server 203 and VPN/proxy server 222 establish a VPN connection between each other, forming a virtual private network (VPN) 231. In some alternative embodiments, a type of connection that is different than VPN is established. Such a VPN connection need only be set up by the resource server once for the corresponding private network, regardless of how many times mobile station 212 accesses the private network.

At process 501, resource server 203 transmits message 502 to VPN/proxy server 222 (83.15.15.15), requesting that such a connection be established.

At process 503, the VPN service provided by VPN/proxy server 222 receives message 502, and establishes a VPN connection assigning private VPN IP addresses to both ends of the connection (addresses 10.0.0.2 and 10.0.0.3 to elements 203 and 222, respectively). As a result, the VPN service is made aware of the specific resource server with which to establish the VPN connection, and the resource server computer has been assigned its private IP address.

At process 504, VPN/proxy server 222 stores the private VPN IP address of server 203, for the purpose of properly recognizing any future messages received that are relevant to server 203. A routing table is updated, indicating the server 203 (10.0.0.2) is reachable via the 10.0.0.3 VPN interface. The routing table associates the two private IP addresses with each other; by extension, the private IP address of server 203 is associated with the public address of VPN/proxy server 222 as well.

Initiating a Secure Connection to Resource Server 203—

Beginning with process 505, mobile station 212 requests that a secure connection with resource server 203 be initiated. Mobile station 212 does so because, as an accessing device, it is being directed (e.g., by its user, by an internal process, etc.) to access data that are available from resource server 203. Mobile station 212 makes the request while operating within mobile network 211, which is outside of private network 201. In some embodiments of the present invention, mobile station 212 initiates the request by first establishing a connection with the public Internet.

At process 505, mobile station 212 transmits message 506 as the initiation request, which specifies both VPN/proxy server 222's public IP address (83.15.15.15) and resource server 203's private IP address (10.0.0.2). Because message 506 specifies the proxy server's public address, the message is routable through public network 221; the message is, in fact, routed to proxy server 222 based on the server's public address having been specified.

In some alternative embodiments of the present invention, the initiation request originates from a source other than the accessing device (i.e., mobile station 212).

Mobile station 212 specifies in message 506 that communication be based on a predetermined cryptographic protocol. In accordance with the illustrative embodiment, the cryptographic protocol used is Hypertext Transport Protocol Secure (HTTPS) layered on top of Secure Sockets Layer (SSL). It will be clear to those with skill in the art, however, after reading this specification, how to make and use embodiments in which the cryptographic protocol used is different than HTTPS/SSL, such as HTTPS layered on top of Transport Layer Security (TLS), for example and without limitation.

At process 507, the proxy service provided by proxy server 222 receives message 506 and reads the contents of the message, including the private IP address of server 203 (10.0.0.2). Because VPN/proxy server 222 has previously associated, by populating the routing table, the VPN interface (having address 10.0.0.3) with resource server 203's private address (10.0.0.2), the proxy service knows to route the relevant contents of initiation request 506 to server 203 via the VPN interface (10.0.0.3), as part of message 508. In other words, because of the VPN connection established in accordance with processes 501 through 504, the proxy is able to “see” server 203's private address (10.0.0.2).

Moreover, because proxy server 222 specifies server 203's address as part of message 508, the message is routable through VPN network 231 and is, in fact, routed to resource server 203, through router 204.

The proxy service provided by proxy server 222 operates in accordance with a socket secure (SOCKS) protocol, as is known in the art, in particular the SOCKS5 protocol. It will be clear to those skilled in the art, however, after reading this specification, how to make and use embodiments in which the proxy service operates in accordance with a protocol other than SOCKS5 or with a protocol other than “socket secure” in general.

At process 509, resource server 203 receives message 508 through the established VPN. In particular, a reverse proxy service running on server 203 is made aware of mobile station 212's initiation request, via message 508.

Performing Handshake with Mobile Station 212—

Beginning at process 510, server 203 performs a handshake with mobile station 212.

As a result of receiving message 509, resource server 203 transmits handshake message 511 to mobile station 212, in accordance with the predetermined cryptographic protocol specified in message 506, in this case an SSL handshake. At process 512, mobile station 212 receives the handshake message, thereby establishing an end-to-end, secure connection (i.e., SSL connection).

Retrieving Resource Device Content—

Beginning at process 513, resource server 203 retrieves unsecured data content on behalf of mobile station 212, from resource device 202 that is also within the same private network 201 as server 203. In some alternative embodiments of the present invention, device 202 and server 203 are in different private networks or are in different networks entirely.

At process 513, resource server 203 transmits message 514 to resource device 202, in accordance with the reverse proxy service running at server 203. Message 514 conveys a request for one or more data packets to be provided by device 202.

In some embodiments, message 514 also conveys control information to resource device 202 for the purpose of controlling the device (e.g., pan up/down, pan left/right, zoom in/out, etc.).

At process 515, device 202 receives message 514 and, in response, at process 516 starts providing data packets to server 203, via message 517 being sent on the shared local area network. In accordance with the illustrative embodiment, in which resource device 202 is a webcam, the device provides unsecured video packets (and possibly audio packets) to server 203. In some embodiments, however, a different resource device (e.g., a baby monitor, etc.) can provide a different type of data packets to server 203.

At process 518, the reverse proxy service provided by resource server 203 prepares one or more payloads to be transmitted to VPN/proxy server 222, comprising the data packets being received from device 202. The reverse proxy service also secures the payloads, by encrypting the data packets in accordance with the cryptographic protocol specified earlier by mobile station 212, for example and without limitation. The reverse proxy service then transmits the secured payloads through the VPN (i.e., via one or more messages 519) to VPN/proxy server 222. Meanwhile, server 222 receives the payloads at process 520 and forwards them (i.e., via one or more messages 521) to mobile station 212. Mobile station 212 receives the payloads at process 522 and provides them to the user or process that requested them in the beginning.

In an example of processes 505 through 522 above, resource device 202 has a pre-assigned address 192.168.1.15, which is mapped by the reverse proxy service as a [/cam1]. In this case, the original message 506 from mobile station 212 would provide a request to connect the mobile to the 10.0.0.2/cam1 device via the 83.15.15.15 proxy. The request would reach the resource server 203 at address 10.0.0.2, where “/cam1” would resolve to the reverse proxy running at server 203, making a client request to 192.168.1.15 (on private local network 201), retrieving the packets, and forwarding them (as if they originated at address 10.0.0.2) back from address 10.0.0.2 up to 10.0.0.3 and then via address 83.15.15.15 to the requesting mobile station.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method comprising:
establishing a first connection between a resource server computer and a second server computer, wherein the resource server computer is assigned a private Internet Protocol (IP) address that is within a private network's address space, wherein the second server computer has a public IP address that is within a public network's address space, and wherein the second server computer provides a socket secure (SOCKS) proxy service;
receiving, by the second server computer, a request to initiate a second connection, wherein the second connection is between an accessing device and the resource server computer, and wherein the initiation request comprises the private IP address assigned to the resource server computer;
routing, by the SOCKS proxy service of the second server computer, the initiation request to the resource server computer via the first connection, wherein the routing is based on the private IP address assigned to the resource server computer; and
establishing the second connection, based on the resource server computer receiving the initiation request.

2. The method of claim 1 wherein the initiation request specifies communication to be based on a predetermined cryptographic protocol, and wherein the establishing of the second connection comprises the resource server computer and the accessing device performing a handshake with each other based on the predetermined cryptographic protocol.

3. The method of claim 1 wherein the first connection is a virtual private network (VPN) connection established by a VPN service provided by the second server computer.

4. The method of claim 3 wherein the establishing of the first connection comprises assigning, by the VPN service, private IP addresses to both ends of the first connection, including the private IP address assigned to the resource server computer.

5. The method of claim 4 wherein the routing is also based on the private IP address that is assigned to the end of the first connection at which the second server computer is situated.

6. The method of claim 1 wherein the initiation request is received from the accessing device.

7. The method of claim 1 further comprising:
requesting, by the resource server computer, one or more data packets from a resource device, in response to the resource server computer receiving the initiation request; and
transmitting, by the resource server computer to the accessing device, the one or more data packets when received from the resource device in response to requesting the packets.

8. The method of claim 7 wherein the resource server computer and the resource device are within a shared private network.

9. The method of claim 8 wherein the accessing device is a mobile station that is operating outside of the shared private network.

10. The method of claim 7 further comprising encrypting the one or more data packets, by the resource server computer and in accordance with a predetermined cryptographic protocol, prior to transmitting the packets.

11. A telecommunications system comprising:
a resource server computer for providing one or more data packets to an accessing device; and
a second server computer for:
i) establishing a first connection with the resource server computer, wherein the resource server computer is assigned a private Internet Protocol (IP) address that is within a private network's address space, wherein the second server computer has a public IP address that is within a public network's address space, and wherein the second server computer is capable of providing a socket secure (SOCKS) proxy service,
ii) receiving a request to initiate a second connection, wherein the second connection is between the accessing device and the resource server computer, and wherein the initiation request comprises the private IP address assigned to the resource server computer, and
iii) routing, by the SOCKS proxy service of the second server computer, the initiation request to the resource server computer via the first connection, wherein the routing is based on the private IP address assigned to the resource server computer;
wherein the resource server is configured to provide the one or more data packets to the accessing device after the second connection has been established based on the resource server computer receiving the initiation request.

12. The telecommunications system of claim 11 wherein the initiation request specifies communication to be based on a predetermined cryptographic protocol, and wherein the resource server computer is also for performing a handshake with the accessing device, based on the predetermined cryptographic protocol and as part of the establishing of the second connection.

13. The telecommunications system of claim 11 wherein the second server computer is also for providing a VPN service, and wherein the first connection is a virtual private network (VPN) connection established by the VPN service.

14. The telecommunications system of claim 13 wherein the second server computer is for establishing the first connection by assigning, by the VPN service, private IP addresses to both ends of the first connection, including the private IP address assigned to the resource server computer.

15. The telecommunications system of claim 14 wherein the routing is also based on the private IP address that is assigned to the end of the first connection at which the second server computer is situated.

16. The telecommunications system of claim 11 wherein the initiation request is received from the accessing device.

17. The telecommunications system of claim 11 wherein the resource server computer is also for:
requesting one or more data packets from a resource device, in response to the resource server computer receiving the initiation request; and
transmitting, to the accessing device, the one or more data packets when received from the resource device in response to requesting the packets.

18. The telecommunications system of claim 17 wherein the resource server computer and the resource device are within a shared private network.

19. The telecommunications system of claim 18 wherein the accessing device is a mobile station that is operating outside of the shared private network.

20. The telecommunications system of claim 17 wherein the resource server computer is also for encrypting the one or more data packets, in accordance with a predetermined cryptographic protocol, prior to transmitting the packets.
